(19) United States
(12) Patent Application Publication
(10) Pub. No.: US 2003/0074317 A1
(43) Pub. Date: Apr. 17, 2003

(54) Device, method and system for authorizing transactions

(76) Inventor: Eyal Hofi, Or Yehuda (IL)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(21) Appl. No.: 09/976,044

(22) Filed: Oct. 15, 2001

(51) Int. Cl. G06F 17/60; H04K 1/00; H04L 9/00

(52) U.S. Cl. 705/44; 705/35; 705/64

(57) ABSTRACT

Device, system and method for authorizing a transaction requested by an authorized user while preventing authorization of a transaction requested by an unauthorized user. The system comprises a user device and a server device. The user device comprises (a) an identity verification unit operable to receive current biometric input from a current user and to utilize that biometric input to determine if the current user is an authorized user of the device; (b) a transaction code provider operable to provide a transaction code if, and only if, the identity verification unit determines that a current user is an authorized user; and (c) a first communication device operable to communicate the provided transaction code. The server device comprises (a) a second communication device operable to receive a communicated code; (b) a transaction code verifier operable to determine if a received communicated code is a transaction code provided by the transaction code provider; and (c) an authorizer operable to authorize a transaction if and only if said transaction code verifier determines that a received communicated code is a verified transaction code.

### FIELD AND BACKGROUND OF INVENTION

The present invention relates to a system, device and method for authorizing transactions by authorized users, while preventing unauthorized users from transacting, using credit and/or debit.

Credit/debit card theft and credit/debit card fraud are well-know problems in the world of business. With the development of e-commerce and other forms of remote purchasing, the problem has been exacerbated, in that today a customer can easily place an order and make a purchase by providing only a credit card number, without needing to demonstrate that he actualy has physical possession of the credit card whose number he provides, and without having to identify himself in a verifiable manner.

In partial response to this and similar problems, various systems have been developed and marketed, utilizing biometric sensing to ascertain or to verify the identity of individuals involved in transactions or requesting access to physical sites and to computer networks. Each issue of Biometric Digest contains dozens of references to new products and services utilizing such biometric devices as fingerprint imaging, voice recognition, retinal pattern scans, signature verification, iris scans, hand geometry scans and facial structure scans, to identify individuals or to verify the ostensible identity of individuals. Applications range from control of access to physical sites and to computer systems, to authorization of financial operations such as payments at ATM machines and unattended supermarket checkout lines.

Information gleaned from biometric sensors is used in a variety of prior art systems to identify individuals, usually by comparing input data to multiple records in a database of previously collected biometric data from many individuals. Police scanning of fingerprints of a person being arrested, to determine if he has a criminal record, is an example of using biometric data to identify an individual. Similarly, biometric information is used in a variety of prior art systems to verify the ostensible identity of an individual, usually by comparing previously stored biometric data from that individual to currently received biometric data from someone purporting to be that individual, to determine if the samples are sufficiently similar to be declared a match. Scanning the fingerprints of the user of a credit card to verify that that user is the legal owner of the card is an example of using biometric data to verify an ostensible identity.

Recent progress in the development of practical biometric sensors of various types has been impressive. Every month sees the announcement of new sensors and new products utilizing them, and the trend is to sensor apparatus that is increasingly more reliable, smaller, cheaper, faster, and easier to use.

Finger-print readers, for example, embodied in devices the size of a computer mouse or smaller, are to be found in the Biolink system from Protective Security Management (www.prosecman.com.au/biolink), in systems from Applied Biometrics Products Inc. (www.appliedbiometrics.net), in access control systems sold by Biometric Identification Inc., of Sherman Oaks, Calif., in PC compatible devices from Shuttle Technology Inc., and in devices from TMN Inc., from BioTech Solutions Sdn Bhd (www.biotechsolutions.com), from NextWave Solutions (www.next-wave-solutions.com), from Kinetic Sciences Inc. (www.kinetic.bc.ca), from Taiwan Tai-Hao Enterprise Co., Ltd (www.tai-hao.com), from Authentec, Inc. (www.authentec.com), from Veridicom Inc., from SGS-Thomson Microelectronics, from Thomson CSF and from Harris Corp., among others.

In a parallel development, the advent of “smart cards”, devices conforming to, or similar to, the ISO 7816 standard (which is incorporated herein by reference), has enabled to provide a form of credit card with the ability to contain large amounts of user-specific data and to engage in complex computational interactions with a business-transactional environment.

Several vendors have utilized smart cards in conjunction with biometric sensing, in schemes designed to verify the identity of a smart card user, typically by recording biometric data derived from an authorized user in the memory of a smart card, then utilizing a biometric sensor in a card reader to glean biometric data from an actual user in real time. A processor, typically in the card reader, is then used to compare biometric data from an authorized user, stored in the card, to biometric data input from a current user, to determine if they are the same person. GemPlus Inc., for example, sells the GemPC-Touch440-Biomet Reader, a device which reads biometric fingerprint information from a user's finger, recalls stored fingerprint information from an authorized user stored in the memory of a smart card, and compares the two. Keyware Technologies (www.keyware.com) also sells a similar device, and U.S. Pat. No. 5,473,144 to Mathurin, which is incorporated herein by reference, describes a device of this sort.

Recent progress in miniaturization of sensors such as fingerprint scanners has reduced the size and power requirements of such devices to such an extent that it begins to be possible to install the sensors directly on a credit card or similar device. PremierElect (www.premierelect.co.uk), sells a fingerprint scanner and identity verification system embodied in a PCMCIA card. AuthenTec Inc, sells several fingerprint scanning modules whose dimensions are substantially compatible with the standardized external dimensions of credit cards and smart cads, as can be seen with respect to their “EntrePad” sensor (www.authentec.com/products/EntrePad Overview.cfm) and their “FingerLoc” sensor (www.authentec.com/products/af-s2.cfm).

However, several important imitations are inherent in all the above-mentioned systems for identity verification and action authorization, and in similar systems.

A disadvantage of some systems is that their use requires the recording of a user's biometric data, such as his fingerprint, in a central database, whence it may be compared to real-time data gleaned from a user during a transaction. Yet, users are typically reluctant to having their fingerprints or other biometric data collected in a database over which they have no control, and are similarly resistant to having their biometric data transmitted over public communications networks, where they are subject to capture and misuse by computer hackers or other criminal elements. As for systems similar to the GemPC-Touch440-Biomet Reader previously mentioned, which systems do not require transmitting a users biometric data over public communications networks, such systems do, however, require communicating authorization-enabling information, such as reports of a user's identity, over communications networks over various sorts, and these communications are also subject to hacking, spoofing, and undesirable and unauthorized activity of various sorts. This problem is particularly acute in contexts in which there is no direct communications link between the device used to verify a user's identity and the device used to authorize a transaction, as is the case, for example, in many contexts of credit card use today.

Thus, there is a widely felt need for, and it would be highly advantageous to have, a system for authorizing activities and transactions which is capable of verifying that a user is an authorized user of a device, yet which does not require the storage of users' fingerprints or other biometric data in a central storage system, and which further does not require the transmission of users' biometric data over data communication systems linking remote terminals to a central authorizing authority, and which enables communicating authorization-enabling information to a central transaction-authorizing authority in a manner which cannot be hacked, spoofed, or otherwise simulated by an unauthorized user. Further, there is a widely felt need for, and it would be highly desirable to have, a system for authorizing actions and transactions which communicates enabling information between a peripheral station and a central authorizing authority in such a manner that acts of intercepting the communication, copying the communication, and reproducing the communication are devoid of any advantage to an unauthorized user or criminal element attempting these activities.

A further disadvantage of such systems as the GemPlus, the Keyware, and the Mathurin systems cited above is that they require, for their use, card readers equipped with a biometric sensor such as a fingerprint scanner, and software compatible with the software systems and/or data formats implemented in the smart card. Such a system is adequate for some applications, particularly applications having a limited number of fixed points of use, such as employee access control at a work site for example. Yet because they require specialized equipment at each usage site, such systems are inadequate as a solution for general-purpose utilizations such as the authorizing financial transactions in the wide-ranging world of travel and commerce.

Thus, there is a widely felt need for, and it would be highly desirable to have, a system for authorizing actions and transactions which comprises a peripheral device, operable to identify a user to the system, which is highly portable and entirely self-contained.

It is a further disadvantage of all known identification and authorization systems that they provide no solution to the difficult problem of enabling secure transactions based on credit card numbers used in absence of a physical credit card. Of course, communication protocols exist which protect data communication of credit card numbers in the context of e-commerce over the Internet, but such systems are of no help at all in preventing unauthorized use of a credit card number in Internet e-commerce, or in a business transaction conducted over the telephone, once an unauthorized user knows his victim's credit card number and the card's expiration date.

Since credit card numbers and the cards' expiration dates may easily be obtained by dishonest employees of legitimate companies, by theft of a credit card, or in a variety of other ways, there is a widely felt need for, and it would be highly desirable to have, a device and system enabling identifying of a credit card user, and authorization of a transaction by such a user over the telephone or the Internet, which protects users, vendors, banks and the credit card companies themselves from fraudulent use of credit card information.

### SUMMARY OF THE INVENTION

According to one aspect of the present invention there is provided a system for authorizing a transaction requested by an authorized user while preventing authorization of a transaction requested by an unauthorized user. The system comprises a user device and a server device. The user device comprises (a) an identity verification unit operable to receive current biometric input from a current user and to utilize that biometric input to determine if the current user is an authorized user of the device; (b) a transaction code provider operable to provide a transaction code if, and only if, the identity verification unit determines that a current user is an authorized user; and (c) a first communication device operable to communicate the provided transaction code. The server device comprises (a) a second communication device operable to receive a communicated code; (b) a transaction code verifier operable to determine if a received communicated code is a transaction code provided by the transaction code provider, and (c) an authorizer operable to authorize a transaction if and only if said transaction code verifier determines that a received communicated code is a verified transaction code.

According to further features in preferred embodiments of the invention described below, the system further comprises modules for executing a business transaction authorized by the authorizer.

According to still further features in the described preferred embodiments, the user device is formed in a size and shape substantially similar to a credit card or a smart card, and preferably conforms to ISO standard 7816.

Preferably, the user device includes a replaceable or rechargeable battery or a power supply of another sort, such as a photocell.

Preferably, the identity verification unit comprises a biometric sensor, which may be a fingerprint sensor such as an optical sensor or a capacitance sensor. Alternatively, the biometric sensor may include a microphone, a sound recording device, a digital camera, a voice recognition system, a retinal pattern scanner, a signature verification system, an iris scanning module, a module operable to measure part of a body of a user such as a feature of a hand or a face, or a module operable to measure a movement or a behavior of a user, or a module operable to characterize a pattern of physical interaction between the biometric sensor and a user.

According to still further features in the described preferred embodiments, the identity verification unit further comprises a first data memory operable to store biometric data of an authorized user. Stored biometric data may be calculated data resulting from a calculation based on at least one sample of input from a biometric sensor operated by a user identified as an authorized user of the user device.

According to still further features in the described preferred embodiments, the identity verification unit further comprises a first processor operable to compare biometric data of an authorized user stored in the first data memory to current biometric data sensed by the biometric sensor. The first processor is further operable to determine that said current user of the user device is an authorized user of the user device whenever detected differences between the biometric data of an authorized user and the current biometric data of a current user are less than a predetermined amount of difference.

According to still further features in the described preferred embodiments, the first communication device of the user device comprises a graphical display module operable to optically display a transaction code provided by the transaction code provider. The graphical display module may include an LCD or a light-emitting element such as an organic compound operable to emit light when electrically powered. Alternatively, the graphics display module comprises a plasma display. The graphics display module is operable to display the transaction code in a machine-readable format such as a barcode or a format readable by an optical character recognition system or in a format readable by a human user. Alternatively, the first communication device comprises a machine readable memory, and further comprises electrical connections operable to enable reading of the machine readable memory by a processor external to the user device. Further alternatively, the first communication device comprises a transmitter such as a radio frequency transmitter, an emitter of optical frequencies or infrared frequencies. Alternatively the transmitter is operable to transmit a transaction code to a receiver, which is operable to transmit the transaction code to a second communication device of the server device. Further alternatively, the transmitter comprises a sound generator operable to generate frequencies audible, or inaudible, to the human ear.

Preferably, the first communication device is operable to communicate the transaction code during a limited lapse of time, and to cease communicating said transaction code at expiration of that lapse of time. Preferably, the lapse of time is less than two minutes duration, and most preferably is about 30 seconds.

According to still further features in the described preferred embodiments, the transaction code provider comprises a first code memory operable to store a set of substantially random digital codes, and a selector operable to select a next transaction code from among codes stored in the first code memory, and a first disqualifier for disqualifying a code stored in the first code memory from future selection by the selector or for removing a transaction code from the first code memory, thereby preventing its future selection by the selector. The transaction code provider is operable to provide a non-predictable transaction code, and is designed and constructed to refrain from providing a transaction code previously provided by the transaction code provider.

According to still further features in the described preferred embodiments, the transaction code verifier comprises a second code memory operable to store a set of substantially random digital codes. Preferably, the second code memory stores such codes. The user device comprises a first code memory storing a first set of substantially random digital codes, and the server device comprises a second code memory storing a second set of substantially random digital codes, the first set of substantially random digital codes and the second set of substantially random digital codes being identical, or substantially similar.

According to still further features in the described preferred embodiments, the transaction code verifier comprises a code tester for testing a received code to determine if the received code is a transaction code provided by the user device. Preferably, the code tester comprises a code searcher operable to compare a received code to codes stored in the second code memory to determine if the received code is identical to a code stored in second code memory, and the authorizer is operable to authorize a transaction if and only if the received code is determined to be identical to a code stored in second code memory. The system preferably includes a second disqualifier operable to disqualify a selected code stored in second code memory when that code is found by the code searcher to be identical to a received code, the disqualification preventing the disqualified code from being examined by the code searcher during subsequent searches of codes stored in second code memory. Also, a second disqualifier may be operable to remove from second code memory a selected code stored in therein when the selected code has been found to be identical to a received code. Alternatively, the transaction code provider comprises a first algorithmic pseudo-random code generator operable to generate a transaction code and the transaction code tester comprises a second algorithmic pseudo-random code generator operable to generate a set of generated codes, said transaction code tester being further operable to compare a received code to each generated code of the set of generated codes, and the authorizer is operable to authorize a transaction if and only if the received code is found to be identical to a generated code belonging to the set of generated codes.

According to still further features in the described preferred embodiments, the user device comprises a portable device and a stationary device. Preferably, the portable device is formed in a size and shape substantially similar to a credit card and comprises a memory operable to store biometric data of an authorized user, and the stationary devices comprises a biometric sensor.

According to another aspect of the present invention there is provided a user-identifying device operable to identify an authorized user thereof, comprising a memory for storing biometric data of an authorized user, a biometric sensor operable to receive current biometric data of a current user, a processor operable to compare said current biometric data of said current user to said stored biometric data of said authorized user, and a communicator operable to communicate information, said information being communicated only if the processor determines that said current biometric data is similar to the stored biometric data.

According to further features in preferred embodiments of the invention described below the device further comprises a transaction code provider operable to provide a non-predictable transaction code useable to provoke authorization of a business transaction by a transaction authorizing authority, the transaction code being provided by the transaction code provider and communicated by the communicator only if the processor determines that the current biometric data is similar to the stored biometric data. According to alternate preferred embodiments, however, the device is operable without reference to a transaction code, being useable to provide confirmation of identify of a current user by communicating information, preferably pre-determined information, if and only if the processor determines that said current biometric data is similar to said stored biometric data.

According to yet another aspect of the present invention there is provided a method for authoring a transaction requested by an authorized user of a transaction authorizing system and for preventing authorization of a transaction requested by an unauthorized user of the transaction authorizing system, the method comprising utilizing a user device to receive biometric data from a current user, compare said received biometric data from a current user to stored biometric data from an authorized user, to determine if they are similar, and provide and communicate a non-predictable transaction code if and only if the stored biometric data from an authorized user and the received biometric data from a current user are determined to be similar, and utilizing a server device to receive a communicated transaction request accompanied by a communicated code, determine whether the received communicated code is a transaction code provided by the user device, and authorize a transaction if and only if the received communicated code is determined to be a transaction code provided by the user device, thereby enabling authorization of a transaction requested by an authorized user, and preventing authorization of a transaction requested by an unauthorized user.

According to still further features in the described preferred embodiments the method further comprises executing a business transaction authorized by the authorizer. Receipt of receiving biometric data from a current user may include receiving fingerprint data, sound data, voice data, optical data, data generated by said current user writing a signature, retinal pattern data, iris pattern data, body part measurement data such as measures of features of a face or a hand, measurements of movements of a user, or of a behavior, or of a pattern of physical interaction between said user device and said current user. Comparing said received biometric data from a current user to said stored biometric data from an authorized user preferably includes determining whether detected differences between said stored biometric data of an authorized user and said received biometric data of a current user are less than a predetermined amount of difference.

According to still further features in the described preferred embodiments, communicating the non-predictable transaction code includes displaying said transaction code on a graphical display module in machine-readable format such as barcode format or a format readable by an optical character recognition system, and/or in a format readable by a human user.

According to still further features in the described preferred embodiments, communicating the non-predictable transaction code includes utilizing a processor external to said user device to read a machine readable memory of said user device.

According to still further features in the described preferred embodiments, communicating the non-predictable transaction code includes receiving communication of a transaction code from said user device and communicating said transaction code to said server device.

According to still further features in the described preferred embodiments, the method further comprises limiting a duration of the communication of the transaction code to a period of less than two minutes, and preferably of approximately 30 seconds.

According to still further features in the described preferred embodiments, the method further comprises providing the transaction code by selecting the transaction code from among a set of substantially random digital codes stored in a memory of the user device, and verifying the received code by determining if a received code is identical to a code stored in a memory of the server device.

According to still further features in the described preferred embodiments, the method further comprises providing a transaction code by utilizing a processor of the user device to generate a transaction code by utilizing a pseudo-random code generation algorithm.

The present invention successfully addresses the shortcomings of the presently known configurations by providing a method, system and device for authorizing activities and transactions capable of verifying that a user is an authorized user of a device, yet not requiring users' fingerprints or other biometric data to be stored in a central storage system, and not requiring transmission of users' biometric data over a data communication system.

The present invention further successfully addresses the shortcomings of the presently known configurations by providing a method, system and device for authorizing activities and transactions wherein authorization-enabling information transmitted over data communication systems is such that intercepting, copying, and reproducing the communication provides no advantage to unauthorized individuals attempting fraudulent interactions with the device and system.

The present invention further successfully addresses the shortcomings of the presently known configurations by providing a method, system and device for authorizing transactions which uses a peripheral device, operable to verify the identify a user of system, which device is highly portable and entirely self-contained.

The present invention further successfully addresses the shortcomings of the presently known configurations by providing a method, system and device for authoring business transactions over the telephone or the Internet, yet which protects users, vendors, bank and the credit card companies from fraudulent use of credit card numbers.

Implementation of the method, system and device of the present invention involves performing or completing selected tasks or steps manually, automatically, or a combination thereof. Moreover, according to actual instrumentation and equipment of preferred embodiments of the method, system and device of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method, system and device of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified functional schematic showing information flow through a transaction authorizing system according to an embodiment of the present invention;

FIG. 2 is a simplified schematic detailing functional elements of a transaction authorizing system according to an embodiment of the present invention;

FIG. 3 is a simplified schematic of a transaction code generation and verification system according to an embodiment of the present invention;

FIG. 4 is a simplified schematic of an alternate construction of a transaction code generation and verification system according to an embodiment of the present invention.

FIG. 5 is a simplified schematic of an alternate preferred construction for a user device, according to an embodiment of the present invention;

FIG. 6 is a simplified schematic providing further detail of a communication device incorporated in a user device, according to a preferred embodiment of the present invention;

FIG. 7 presents several views of a recommended physical format of a smart card, according to an embodiment of the present invention; and

FIG. 8 is a simplified flow chart of a method for authorizing a transaction, according to an embodiment of the present invention.

### DESCRIPTION OF THE PREFERRED EMBODIMENTS

The present invention is of a device, system and method for authorizing a transaction such as a business transaction, the system comprising a user device providing an non-predictable transaction code upon receipt of biometric input identifying a current user as an authorized user, and further comprising a server device operable to verify that a received code is a valid transaction code provided by a user device, and further operable to authorize a transaction in response to receipt of a valid transaction code. Specifically, the present invention can be used to control business transactions involving credit cards in a convenient and highly secure manner.

The principles and operation of an authorizing system according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

It is to be noted that the term “transaction” as used herein refers not only to financial and business transactions, but also to any sort of action or commerce which might be subject to authorization by an automated authorization system. Thus, for example, the requesting and granting of physical access of a person to a building, and the requesting and granting of log-in privileges of a person to a computer system, are “transactions” as that term is used herein.

The term “biometric information” refers to any data gleaned by sensory contact with a user, typically by automated means. The term “biometric sensor” refers to any device useable to detect and optionally also to analyze such information. Fingerprint imaging, voice recognition systems, retinal pattern scans, signature verification, iris scans, hand geometry scans and facial structure scans are examples of biometric sensors, as are other devices operable to observe and report other forms of physical measurement of the body of a user or of the behavior of a user. Any such device is a “biometric sensor” as this term is used herein.

Biometric data typically undergoes some degree of abstraction when being stored or compared by such systems. Thus, a fingerprint identification system might operate by preserving in graphic format an image of a fingerprint, and then using graphics techniques to compare stored images to new images. Yet, a more efficient and more typical use of fingerprint data is to utilize computational techniques to abstract information from the raw image, which abstracted information constitutes a form of description of the image, and to store the abstracted information, rather than the image itself. Comparisons can then be made between stored abstracted information and new abstracted information gleaned from a currently presented image. The term “biometric information” is generally used herein to refer to all levels of abstraction of such information, from the raw data as received from a sensor to highly abstracted descriptive information such as a classification of patterns of lines on a fingerprint into categories of patterns, or a count of the number of junctures at which individual lines of a fingerprint divide into two lines in a “Y” juncture.

The system of the present invention comprises a first device which in a preferred embodiment is a peripheral device, and which is termed a “user device” herein. The system further comprises a second device capable of receiving information generated by a user device, and operable to authorize transactions. In a preferred embodiment the second device is typically enabled to receive information from a plurality of peripheral device, and is operable to authorize transactions for a plurality of users, consequently the second device is termed a “server device” herein. Yet, in an alternative embodiment, the server device may be designed and built to receive information from a single user device, or to authorized transactions of a single user.

In typical use of preferred embodiments of the present invention, a user provides biometric data, such as a fingerprint, to a peripheral user device in order to be identified as an authorized user of the user device, and thereby to gain authorization to receive a product or service controlled by a central server device. The present invention is not, however, limited to this specific context. According to alternative embodiments, a system according to the present invention can be used in any context in which biometric data of an individual is presented to a user device as described hereinbelow, regardless of how the biometric data is obtained. In descriptions of embodiments presented hereinbelow, the term “user”, in the context of “a user of the user device,” is generalized to include any individual whose biometric information is input to, and evaluated by, the user device, regardless of whether his “use” of the system is intentional on his part.

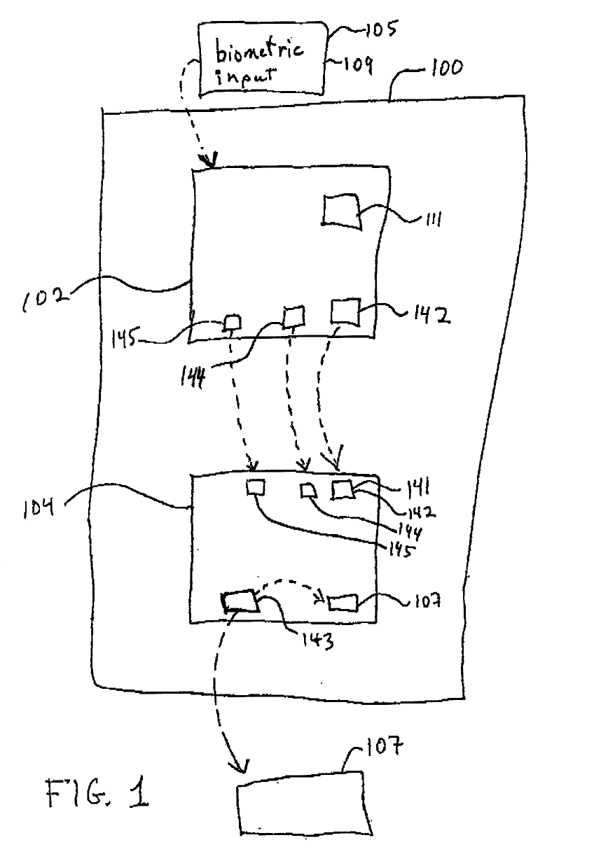

Referring now to the drawings, FIG. 1 is a simplified functional schematic showing information flow through a transaction authorizing system according to an embodiment of the present invention.

System 100 relates a user device 102 and a server device 104. System 100 is useable by a user to achieve authorization of a requested transaction, and provides safeguards against attempted authorization of a transaction by an unauthorized user.

User device 102 is operable to verify that a current user of user device 102 is an authorized user thereof. In preferred embodiments, a current user provides current biometric data 105, such as a fingerprint 109, to peripheral user device 102. User device 102 compares current biometric data 105 to stored biometric data 111 of an authorized user, to determine if the two are sufficiently similar to be considered a match. If, and only if, current data 105 is similar to stored data 111, is a current user considered a verified authorized user of user device 102.

User device 102 is further operable to respond to a successful verification that a current user is an authorized user by providing an authorizing transaction code 142, which may then be communicated to server device 104. Typically, user device 102 issues a transaction code in support of an authorized user's request for a product or service controlled by a central server device 104.

In a preferred embodiment, server device 104 is utilized in conjunction with a plurality of user devices 102. In this embodiment, each transaction code 142 communicated by user device 102 is accompanied by an identification code 144 identifying a particular user device 102 as originator of that transaction code 142. In preferred embodiments, each transaction code is further accompanied by a transaction request 145 specifying the transaction that the user desires to have authorized. For example, in a particularly preferred embodiment described in further detail hereinbelow, user device 102 is formed as a credit card and is useable as a credit card, and a typical transaction communication includes identification code 144 in the form of a credit card number and expiration date, a transaction code 142 provided by user device 102, and a transaction request 145 in the form of a typical credit card transaction request, such as a request for payment of a particular amount to a particular party such as a vendor of goods or services.

Server device 104 is operable to receive a communicated code 141 which is ostensibly a transaction code 142, to examine the validity of received code 141, and to authorize a transaction if received code 141 is valid, that is, if received code 141 is judged to be a transaction code 142 provided by user device 102.

Thus, in the general information flow depicted in FIG. 1, biometric input from a user, entered into system 100 by way of user device 102, eventuates, on condition that the user is an authorized user, in a transaction authorization message 143 created by server 104. Transaction authorization message 143 is typically transmitted to a transaction execution system 107, which executes the requested transaction. Transaction execution system 107 may be embodied within system 100, or alternatively may be external to system 100.

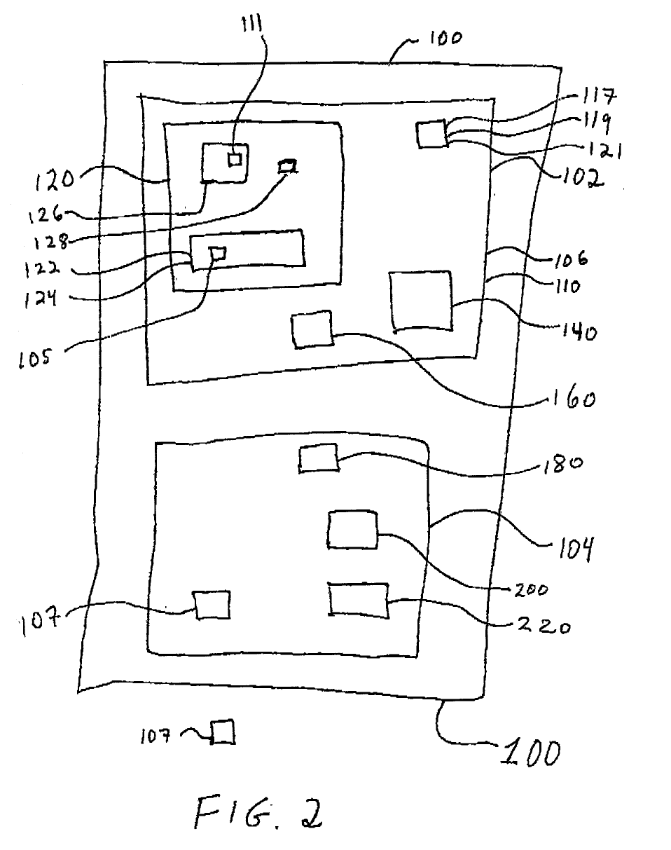

Attention is now drawn to FIG. 2, which is a simplified schematic providing further detail of various functional units of system 100, according to a preferred embodiment of the present invention.

User device 102 includes an identity verification unit 120 operable to receive biometric data of a user and to compare it to previously stored biometric data of an authorized user, to determine if they match, that is, if the two are similar within some defined degree of tolerance of difference.

In a preferred embodiment, user device 102 is formed as a credit card 106 or a smart card 110. Identity verification unit 120 includes a biometric sensor 122, such as a fingerprint sensor 124, for example an optical fingerprint sensor or a capacitance-sensitive fingerprint sensor, for receiving biometric input from a user. Identity verification unit 120 further includes a first data memory 126 usable to store biometric data 111 of an authorized user, and a first processor 128 operable to compare stored biometric data 111 to current-user data 105 based on input received in real time during a execution of a transaction request, from biometric sensor 122. Processor 128 is used to compare stored data 111 to current-user data 105, and to decide if the two are sufficiently similar to be considered a match.

In a preferred embodiment, user device includes a power source 117 such as a battery 119 or a photocell 121 to provide electrical energy to first processor 128 and first data memory 126. Battery 119 is preferably a replaceable battery, yet battery 119 may also be a rechargeable battery. First data memory 126 is preferably a memory such as a flash memory capable of retaining stored information even when temporarily disconnected from power source 117. Alternatively, power source 117 will include connections enabling to provide external power to first data memory 126 during replacement of battery 119.

If the two are not considered a match by processor 122, then the transaction authorization process per se stops at that point. In other words, the illegal user of a stolen credit card designed and constructed according to an embodiment of the present invention will not be able to get authorization for a transaction using the stolen card, because that illegal user's fingerprint (or other biometric data) won't be recognized as similar to the stored fingerprint (or other biometric data) of the authorized user who is the legal owner of the card.

It is noted that whereas in a currently preferred embodiment biometric sensor 122 is fingerprint sensor 124, in alternative embodiments biometric sensor 122 is any biometric sensor capable of supplying input which may be analyzed and compared to stored biometric data of an authorized user. In particular, in this and in other embodiments described herein, sensor 122 may include a fingerprint imaging device, a voice recording device, a microphone, a digital camera, a sound-recording device, a voice recognition systems, a retinal pattern scanner, a signature verification system, an iris scanning device, a module for measuring hand geometry, a module for measuring facial structure, a module for measuring or describing the geometry of any other part of a user's body, a module for measuring or characterizing a behavior of a user, such a module for measuring a reaction time of a user to a stimulus, and a module for measuring or characterizing a pattern of interaction between sensor 122 and a user, such as a module for measuring or characterizing patterns in a user's input when that user attempts to copy a graphic stimulus presented to the user for copying.

If current user input and authorized user input do match, user device 120 proceeds to communicate this fact. In a preferred embodiment, a transaction code provider 140 is operable to provide a transaction code 142 if, and only if, identity verification unit 120 determines that a current user is indeed an authorized user. Transaction code 142 functions as an intermediary communication code, provided by user device 102 to be received by server device 104. Transaction code 142, provided by transaction code provider 140, is communicated outside of user device 102 by a first communication unit 160. Transaction code 142 may be communicated directly from user device 102 to server device 104, or alternatively transaction code 142 may be communicated to server device 104 through a variety of indirect pathways, as will be further described hereinbelow.

Server device 104 includes a second communication unit 180, operable to receive communicated codes 141 which are ostensibly transaction codes 142, and, optionally, to further receive user device identification codes 144 and transaction requests 145. A transaction code verifier 200 is operable to verify that a received code 141 is a valid transaction code 142. Server device 104 further includes an authorizer 220 operable to authorize a transaction upon receipt of a transaction request accompanied by a transaction code 142 whose validity has been verified by transaction code verifier 200. Typically, authorizer 220 authorizes a transaction by sending a transaction authorization message 143 to a transaction execution system 107 operable to execute a requested transaction. In one preferred embodiment, transaction execution system 107 is external to system 100. In an alternate preferred embodiment, transaction execution system 107 is included in system 100.

Transaction code 142 is communicated between user device 102 and server device 104. Communication between the two may be direct, as in a leased phone line, or it may be quite indirect, as in the case where user device 102 communicates transaction code 142 visually to the user, who then communicates it via face-to-face conversation, by phone or by email to a third party such as a vendor of goods and services, which third party then communicates it to a credit card company as part of a request for payment, which credit card company communicates it to server 104 in a request for authorization of the requested payment.

It is noted that in alternative embodiments, user device 120 may provide a useful service when utilized on a stand-alone basis, that is, when utilized without transmitting a transaction code 142 to be received by server device 104. Thus, in an embodiment wherein user device 120 is implemented, for example, as an employee's identity card, or a national identity card, or as some other form of personal identity card, first communication unit 160 is operable to communicate outside of user device 120 (e.g., by an appropriate display) the fact that there exists a match between current user input and authorized user input, thereby demonstrating to any interested party that the holder of such an identity card is indeed the authorized holder of that identity card, and not some other person.

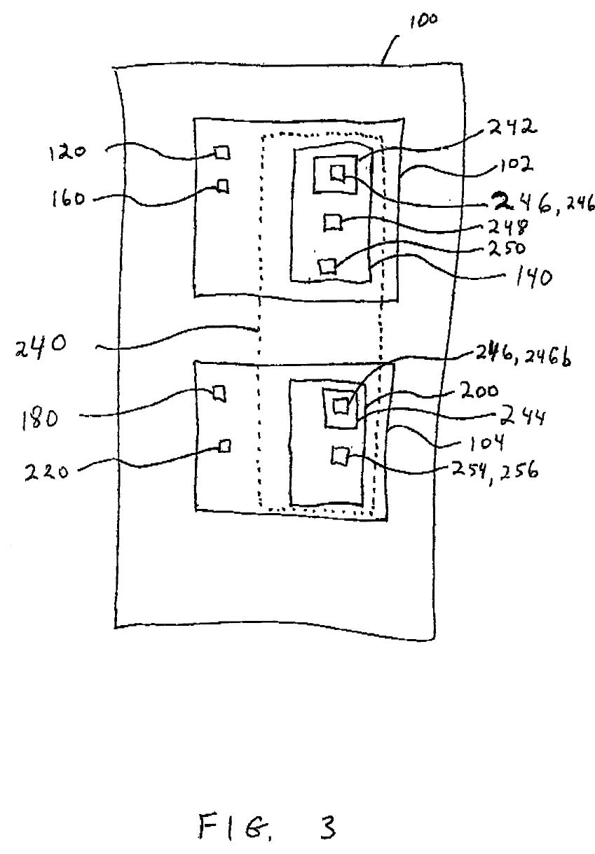

Attention is now drawn to FIG. 3, which is a simplified schematic of a transaction code generation and verification system according to a preferred embodiment of the present invention.

Since traction code 142 may be communicated indirectly to server device 104, it is highly desirable that the transaction code 142 be secure in two ways. First, it is desirable that transaction code 142 not be easily forged, predicted or simulated by an outside party, such as a sophisticated hacker. Second, it is desirable that transaction code 142 be such that subsequent reproduction and re-use of a previously used transaction code 142 will not profit an unauthorized user attempted to spoof the system.

Presented is a code generation and verification system 240 which comprises a transaction code provider 140 included in user device 102, and a transaction code verifier 200 included in server device 104.

Since it is desirable that transaction code 142 be such that no unauthorized user or system can easily predict it or simulate it, transaction code 142 must be a non-predictable code, in the sense that it cannot be predicted by an outside person or system, such as a hacker.

According to a preferred embodiment of the present invention presented in FIG. 3, system 100 is provided, during an initialization phase, with a set of digital codes 246. Set 246 is a set of individually selectable digital codes useable as transaction codes 142. The digital codes comprising set 246 are random digital codes such as may be gleaned from analyses of random natural processes such as radio noise from cosmic sources. Alternatively, set 246 may be constructed of what is known in the art as “pseudo-random” codes, which are digital sequences generated by mathematical algorithms useable to produce series of digital codes which, while not necessarily truly random, are certainly unpredictable for any practical purposes. (The RND( ) functions of standard computer languages running on PC computers produce pseudo-random numbers of this sort.)

The size of set 246 is preferably sufficiently large to exceed the number of authorized transactions likely to be requested by authorized users during the expected lifetime of user device 102. For example, in a preferred embodiment in which user device 102 is implemented as a credit card or smart card, set 246 would preferably contain between 1000 and 10000 codes, and most preferably about 3000 codes, this being a number expected to exceed the number of requests for transactions expected to be made during the physical or legal life of a credit card in a typical population of credit-card users. Of course, the size of set 246 may be optimized at other sizes for other populations of users, in other uses, or in other embodiments.

The number of digits included in each code of set 246 is preferably sufficiently large to prevent any likelihood of an unauthorized user hitting on a legitimate transaction code 142 just by guessing. Thus, each transaction code 142 will preferably include at least 6 digits and preferably 8 or more digits, say between 10 and 20 digits.

A first copy of set 246, designated 246a, is stored in a fist code memory 242 included in transaction code provider 140. Transaction code provider 140 provides a transaction code 142 by operating a selector 248, which may be a processor or other device, to select a next transaction code from among the codes stored in first code memory 242 as set 246a. The selected code is then passed to first communicator 160, for use in furthering a transaction.

Transaction code provider 140 also operates a first disqualifier 250 to disqualify the selected code 142 from being re-selected in the future. That is, first disqualifier 250 removes the selected transaction code 142 from set 246a.

A second copy of random code set 246, designated 246b, is stored in a second code memory 244 included in transaction code verifier 200 of server device 104.

Transaction code verifier 200 includes a code tester 254 for testing a received code 141 to determine if received code 141 is a transaction code 142. In the embodiment presented in FIG. 3, code tester 254 is a code searcher 256, operable to search among the codes of set 246b to determine if received code 141 is among them.

If received code 141 is not found within set 246b, then received code 141 is not a legitimate transaction code 142, transaction code verifier 200 does not validate received code 141, and server device 104 does not authorize the requested transaction.

If received code 141 is found within set 246b, then transaction code verifier 200 does validate received code 141 and informs authorizer 220 that a valid transaction code 142 has been received, whereupon authorizer 220 authorizes a transaction. Optionally, authorizer 220 may be further operable to utilize additional information, such as a user's credit status and bank balance, to further determine whether to authorize a transaction.

If received code 141 is, found within set 246b, then transaction code verifier 200 also operates a second disqualifier 260 to disqualify the received transaction code 142 from being re-validated in any future transaction request. That is, second disqualifier 260 removes the selected transaction code 142 from set 246b.

Disqualifiers 250 and 260 protect system 100 from abuse by unauthorized users who become aware of the details of an authorized transaction. In general, to prevent subsequent re-use of a transaction code 142 (e.g., by a hacker), transaction code provider 140 is designed and constructed to issue any particular transaction code 142 only once. That is, a particular code, once issued by a user device 102, will not be issued again by that user device 102. In the embodiment presented in FIG. 3, transition codes 142 are selected from a finite set of codes 246a, and any code so selected is removed from set 246a so that it cannot again be selected. (Preferably, set 246 contains no duplicate codes.)

Similarly, server 104 is designed and constructed such that it will not validate a particular transaction code, received from a particular user device, more than once. Server device 104, having authorized a transaction based on receipt from a particular user device 102 of a particular transaction code 142, will not again honor that transaction code 142 if it is presented subsequently in support of another transaction request from the same user device 102. Thus, even should an eavesdropper or a hacker gain access to all the details of a transaction, including identity of the user, the identity of his user device (e.g., the number and expiration data of his credit card), and a transaction code 142 produced by his client 102 and recognized by server 104, server 104 will ignore (or optionally take further defensive steps against) any further attempt to re-use that particular transaction code 142 to achieve authorization of an additional transaction.

Thus, in preferred embodiments of the present invention, only an authorized user can use user device 102 to initiate a transaction request, and only an authentic transaction code provided by user device 102 will be validated by server device 104 and lead to authorization of the requested transaction.

In a preferred embodiment, care is taken to construct user device 102 using technologies such as smart card construction technologies well known in the art, to render difficult the unauthorized reading of memory devices of user device 102, or other deconstruction or reverse engineering of user device 102 by an unauthorized user with criminal intent.

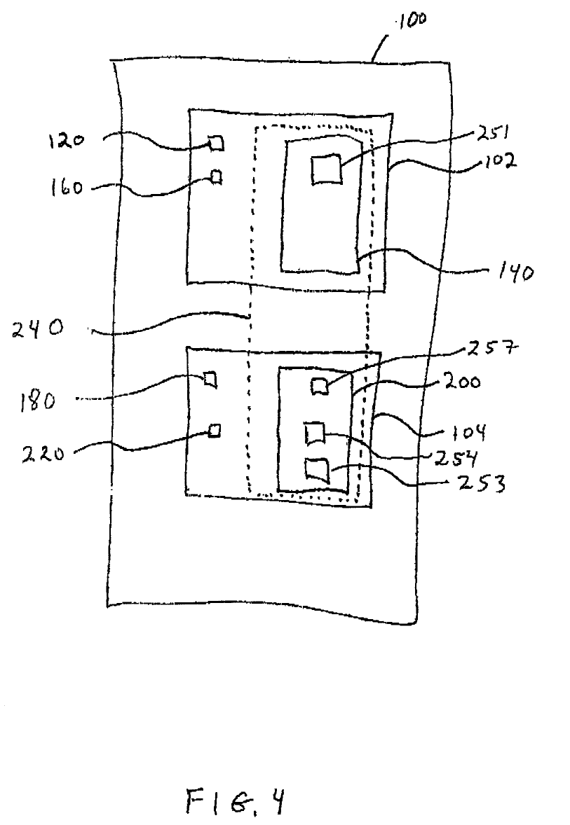

Attention is now drawn to FIG. 4, which is a simplified schematic of an alternate construction of a transaction code generation and verification system 240 according to a preferred embodiment of the present invention.

A first algorithmic random code generator 251 is included in transaction code provider 140, and a second algorithmic random code generator 253 is included in transaction code verifier 200. In a preferred embodiment, algorithmic random code generators 251 and 253 are pseudo-random code generators similar to those provided by standard programming languages running on PC computers, wherein a “seed” in the form of an initial numerical value is useable by a computational algorithm to produce a substantially random string of digital codes. The string of codes so produced is invariant, in that given a particular algorithm and a particular seed, such a code generator will produce an identical string of digital codes every time. Yet, the produced codes are non-predictable in that an outsider, not having specific knowledge of both the algorithm and the seed, cannot predict the code sequence which will be generated.

In the preferred embodiment presented in FIG. 4, generators 251 and 253 are initialized to a same algorithm and seed. To produce a next transaction code 142, first algorithmic random code generator 251 is operated to produce a sequence of digits. Each time generator 251 is operated, it produces the continuation of that sequence, thus guaranteeing that no code 142 is issued more than once, except as a highly unlikely random happenstance.

In the embodiment presented in FIG. 4, code tester 254 tests whether a received code 141 is a transaction code 142 by operating generator 253, from its initial seed value, for some finite maximum number of iterations, e g., up to 3000 iterations. The code generated by each iteration of operation of generator 253 is compared to received code 141. If no match is found after a predetermined maximum number of iterations, code 141 is not validated.

If a match is found, the iterative code generation process ceases and tester 254 checks in a used-code memory 257 to determine if the matched code 141 has already been used. If so, code 141 is not validated. If not, code 141 is validated as a valid transaction code 142, and is stored in used-code memory 257 to insure that it cannot be used again.

In the embodiment presented in FIG. 2, user device 102 is formed as credit card 106, a smart card 110 or a similar light and portable object. Sensor 122 is designed and constructed incorporated in the card, and all processors and memories are on the card as well.

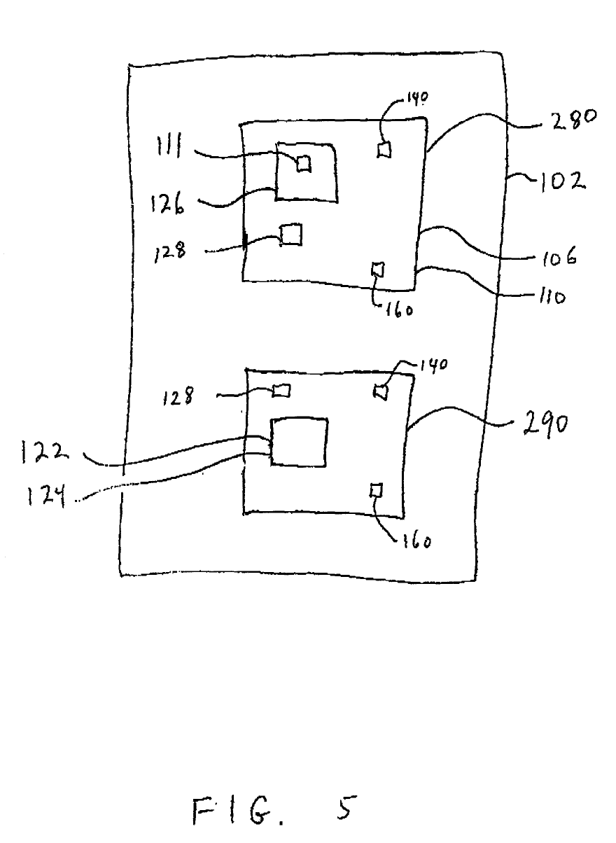

Attention is now drawn to FIG. 5, which presents an alternate preferred construction for user device 102, wherein user device 102 comprises two physically separate devices, and various functional elements of user device 102 described hereinabove are distributed among those elements. FIG. 5 presents an example in the form of a preferred embodiment of the present invention, wherein user device 102 is implemented as a portable user device 280 and a stationary user device 290.

In a particularly preferred embodiment of the present invention, portable device 280 is a credit card 106 or smart card 110, having a first data memory 126 operable to store biometric data 111 of an authorized user. Stationary device 290 includes biometric sensor 122 such as fingerprint scanner 124.

In one preferred construction, processor 128 is included in stationary device 290, and biometric data from sensor 122 is compared to stored data 111 transmitted from portable user device 280 to stationary device 290. In an example of this construction, portable device 280 is a credit card 106 having a magnetic strip storing the stored information, and stationary device 290 includes a magnetic strip reader from reading the stored information.

In an alternative preferred construction, portable device 280 is a smart card 110 having a memory, and stationary device 290 is a smart card reader. In this construction, processor 128 is included on portable device 280, and biometric data from sensor 122 is transmitted from stationary device 290 to portable device 280, where the comparison takes place.

The examples here presented are intended to be illustrative but not limiting. It is clear that various other placements and combinations of the essential elements of user device 102 are possible. Transaction code provider 140 and first communicator 160 may be on either portable device 280 or stationary device 290. It is noted that the essential characteristics of the embodiment here described are unchanged if portable device 280 is in fact designed and constructed as a non-portable unit, or if stationary device 290 is in fact embodied in a form which is portable.

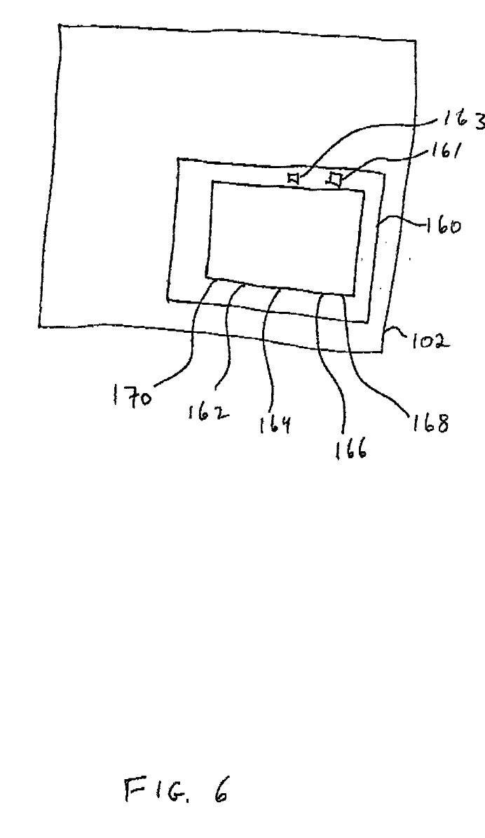

Attention is now drawn to FIG. 6, which is a simplified schematic providing further detail of a communication device 160, according to a preferred embodiment of the present invention.

It is noted that communication device 160 may be, or include, data communication devices of any sort, including, but not limited to, a radio-frequency communication device, an optical communication device, an infra-red communication device, and an auditory communication device emitting sounds either audible or inaudible to the human ear. Alternatively, communication device 160 may include a machine-readable memory 161 and a set of connectors 163 enabling machine readable memory 161 to be read by a reader external to user device 102.

In a preferred embodiment, first communication device 160 is a graphic display device. FIG. 6 provides details of a user device 102 in which communication device 160 is implemented as a graphics display screen 162. Graphics display screen 162 may be implemented as an LCD display 164, or as a light-emitting display 166 such as a plasma display 168 or an organic-compound display 170 incorporating light-emitting organic compounds.

In a preferred embodiment, display screen 162 is enabled to display transaction code 142 in a human-readable digital display, in a machine-readable barcode display, in a machine-readable two-dimensional barcode display, in a font readable both by humans and by machines, and in a machine-readable time-dependant (e.g., flashing) display. In this embodiment, a user, having provided a fingerprint or other biometric input to user device 102, is enabled to read transaction code 142 directly from graphics display screen 162. Alternatively, transaction code 142 displayed on graphics display 162 in machine readable format can be read automatically by an appropriate reader, such as the barcode reader of a supermarket checkout counter, which is optionally enabled to transmit transaction code either directly or indirectly to server device 104.

To prevent misuse of device 102 by an unauthorized user, communication of transaction code 142, e.g., display of transaction code 142 on display 162, is preferably limited in time, preferably to two minutes or less, and most preferably to about 30 seconds or less. Thus, a user can easily obtain a transaction code and supply that code along with his credit card number to a vendor of goods and services, yet can be confident that no unauthorized user can obtain a transaction code from his card once that code has disappeared from graphics screen 162.

In a currently preferred embodiment an authorized user obtains transaction code 142 by the simple expedient of pressing his finger to a fingerprint sensor on his credit card, after which the authorized user can read a transaction code directly off the card so as to provide it to a vendor over the telephone or over the Internet, or the authorized user can cause it to display in a form such as a barcode which is directly readable by a store checkout counter. Each time the authorized user presses his finger to the fingerprint sensor, a new and unique transaction code 142 is produced and communicated (e.g., displayed). Further, the authorized user can be confident that no unauthorized user will be able to obtain any additional transaction codes from his card, since no unauthorized user can provide authorized user's biometric input. Further, the authorized user can be confident that a transaction code once used cannot be used again for an additional transaction.

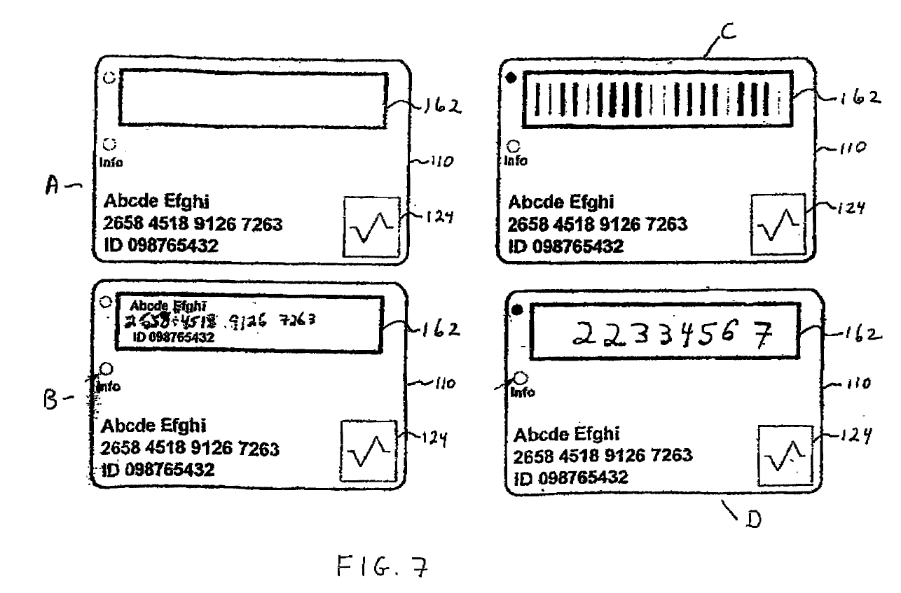

FIG. 7 presents several views of a recommended format of an embodiment of the present invention, wherein user device 102 is formed as a smart card 110 utilizing, as a communications device 160, a graphics display screen 162. Graphics display 162 is alternatively shown as (a) blank, (b) displaying user's name and credit card number and an identification number such as a bank branch and account number (c) presenting a number, including transaction code 142 and optionally including a credit card number, in machine-readable barcode format, and (d) presenting a number, in including transaction code 142 and optionally including a credit card number, in human-readable format.

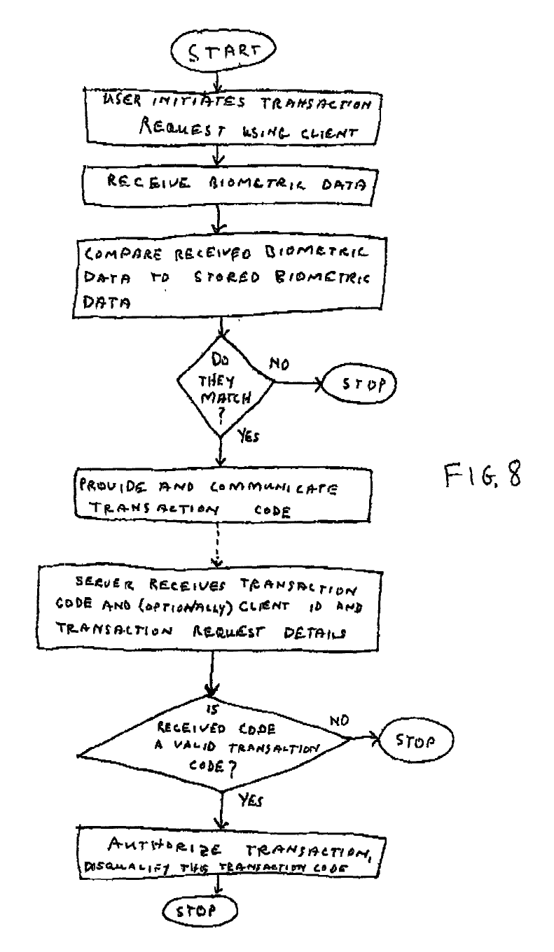

FIG. 8 is a simplified flow chart summarizing a method for authorizing a transaction, according to an embodiment of the present invention.

A transaction request is initiated by a user, who provides biometric input to a user device 102. An identity verification unit of a user device compares received biometric input 105 to previously stored biometric data 111 of an authorized user. If the two sets of biometric data are sufficiently similar, user device 102 provides a transaction code 142 which is communicated outside the user device. If biometric input provided by a user is not sufficiently similar to stored biometric data of an authorized user, then no transaction code is provided.

Provided transaction code 142 may be communicated directly to a user or directly to server device 104, or transaction code 142 may be communicated to a third party such as a supplier of goods and services to whom the user wishes to make a payment, and who will in turn communicate it, directly or indirectly, to server device 104.

When a transaction request accompanied by a code is received by server device 104, the received code is tested to determine if it is a valid transaction code for the user device which purportedly supplied it. If it is, then server 104 authorizes the requested transaction. If it is not, server 104 does not authorize the requested transaction. Each validated transaction code is disqualified from being re-validated in future transactions.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A transaction authorization system for authorizing a transaction requested by an authorized user while preventing authorization of a transaction requested by an unauthorized user, comprising:
(a) a user device which comprises:
(i) an identity verification unit operable to receive current biometric input from a current user, and to utilize said current biometric input to determine if said current user is an authorized user of said user device;
(ii) a transaction code provider operable to provide a transaction code if, and only if, said identity verification unit determines that a current user is an authorized user of said user device; and
(iii) a first communication device operable to communicate said transaction code; and
(b) a server device which comprises:
(i) a second communication device operable to receive a communicated code;
(ii) a transaction code verifier operable to determine if said received communicated code is a transaction code provided by said transaction code provider; and
(iii) an authorizer operable to authorize a transaction if and only if said transaction code verifier determines that said received communicated code is a transaction code provided by said transaction code provider.

2. The system of claim 1, further comprising a system for executing a business transaction authorized by said authorizer.

3. The system of claim 1, wherein said user device is formed in a size and shape substantially similar to a credit card.

4. The system of claim 1, wherein said user device is a smart card.

5. The system of claim 1, wherein said user device conforms to ISO standard 7816.

6. The system of claim 1, wherein said user device includes a battery.

7. The system of claim 6, wherein said battery is a replaceable battery.

8. The system of claim 6, wherein said battery is a rechargeable battery.

9. The system of claim 1, wherein said user devices comprises a photocell operable to supply power to said user device.

10. The system of claim 1, wherein said identity verification unit comprises a biometric sensor.

11. The system of claim 10, wherein said biometric sensor comprises a fingerprint sensor.

12. The system of claim 11, wherein said fingerprint sensor comprises an optical sensor.

13. The system of claim 11, wherein said fingerprint sensor comprises a capacitance sensor.

14. The system of claim 10, wherein said biometric sensor comprises a microphone.

15. The system of claim 10, wherein said biometric sensor comprises a sound recording device.

16. The system of claim 10, wherein said biometric sensor comprises a digital camera.

17. The system of claim 10, wherein said biometric sensor comprises a voice recognition system.

18. The system of claim 10, wherein said biometric sensor comprises a retinal pattern scanner.

19. The system of claim 10, wherein said biometric sensor comprises a signature verification system.

20. The system of claim 10, wherein said biometric sensor comprises an iris scanning module.

21. The system of claim 10, wherein said biometric sensor comprises a module operable to measure part of a body of a user.

22. The system of claim 21, wherein said biometric sensor comprises a module operable to measure features of a hand of a user.

23. The system of claim 21, wherein said biometric sensor comprises a module operable to measure features of a face of a user.

24. The system of claim 10, wherein said biometric sensor comprises a module operable to measure a movement of a user.

25. The system of claim 10, wherein said biometric sensor comprises a module operable to measure a behavior of a user.

26. The system of claim 10, wherein said biometric sensor comprises a module operable to characterize a pattern of physical interaction between said biometric sensor and a user.

27. The system of claim 10, wherein said identity verification unit further comprises a first data memory operable to store biometric data of an authorized user.

28. The system of claim 27, further comprising biometric data of an authorized user stored in said first data memory.

29. The system of claim 28, wherein said biometric data of an authorized user is a calculated data resulting from a calculation based on at least one sample of input from a biometric sensor operated by a user identified as an authorized user of said user device.

30. The system of claim 27, wherein said identity verification unit further comprises a first processor operable to compare biometric data of an authorized user stored in said first data memory to current biometric data sensed by said biometric sensor.

31. The system of claim 30, wherein said first processor is further operable to determine that said current user of said user device is an authorized user of said user device whenever detected differences between said biometric data of an authorized user and said current biometric data of a current user are less than a predetermined amount of difference.

32. The system of claim 1, wherein said first communication device of said user device comprises a graphical display module operable to optically display a transaction code provided by said transaction code provider.

33. The system of claim 32, wherein said graphical display module comprises an LCD.

34. The system of claim 32, wherein said graphical display module comprises a light-emitting element.

35. The system of claim 34, wherein said light-emitting element comprises an organic compound operable to emit light when electrically powered.

36. The system of claim 32, wherein said graphics display module comprises a plasma display.

37. The system of claim 32, wherein said graphical display module is operable to display said transaction code in a machine-readable format.

38. The system of claim 37, wherein said graphical display module is operable to display said transaction code in barcode format.

39. The system of claim 37, wherein said graphical display module is operable to display said transaction code in a format readable by an optical character recognition system.

40. The system of claim 32, wherein said graphical display module is operable to display said transaction code in a format readable by a human user and also readable by an optical character recognition system.

41. The system of claim 32, wherein said graphical display module is operable to display said transaction code in a format readable by a human user.

42. The system of claim 1 wherein said first communication device comprises a machine readable memory, and further comprises electrical connections operable to enable reading of said machine readable memory by a processor external to said user device.

43. The system of claim 1, wherein said first communication device comprises a transmitter.

44. The system of claim 43, wherein said transmitter comprises an emitter of radio frequencies.

45. The system of claim 43, wherein said transmitter comprises an emitter of optical frequencies.

46. The system of claim 43, wherein said transmitter comprises an emitter of infrared frequencies.

47. The system of claim 43, wherein said transmitter is operable to transmit said transaction code to a receiver, said receiver being operable to transmit said transaction code to said second communication device of said server device.

48. The system of claim 43, wherein said transmitter comprises a sound generator.

49. The system of claim 48, wherein said sound generator is operable to generate frequencies audible to the human ear.

50. The system of claim 48, wherein said sound generator is operable to generate frequencies inaudible to the human ear.

51. The system of claim 1, wherein said first communication device is operable to communicate said transaction code during a limited lapse of time, and to cease communicating said transaction code at expiration of said lapse of time.

52. The system of claim 51, wherein said lapse of time is less than two minutes duration.

53. The system of claim 51, wherein said lapse of time is approximately 30 seconds.

54. The system of claim 1, wherein said transaction code provider comprises a first code memory operable to store a set of substantially random digital codes.

55. The system of claim 54, wherein said transaction code provider further comprises a selector operable to select a next transaction code from among codes stored in said first code memory.

56. The system of claim 55, further comprising a first disqualifier for disqualifying a code stored in said first code memory from future selection by said selector.

57. The system of claim 55, further comprising a first disqualifier operable to remove a transaction code from said first code memory, thereby preventing its future selection by said selector.

58. The system of claim 1, wherein said transaction code provider is operable to provide a non-predictable transaction code.

59. The system of claim 58, wherein said transaction code provider is designed and constructed to refrain from providing a transaction code previously provided by said transaction code provider.

60. The system of claim 1, wherein said transaction code verifier comprises a second code memory operable to store a set of substantially random digital codes.

61. The system of claim 60, further comprising a set of substantially random digital codes stored in said second code memory.

62. The system of claim 1, wherein said user device comprises a first code memory storing a first set of substantially random digital codes, and said server device comprises a second code memory storing a second set of substantially random digital codes, said first set of substantially random digital codes and said second set of substantially random digital codes being identical.

63. The system of claim 1, wherein said user device comprises a first code memory storing a first set of substantially random digital codes, and said server device comprises a second code memory storing a second set of substantially random digital codes, said first set of substantially random digital codes and said second set of substantially random digital codes being substantially similar.

64. The system of claim 63, wherein said transaction code verifier comprises a code tester for testing a received code to determine if said received code is a transaction code provided by said user device.

65. The system of claim 64, wherein said code tester comprises a code searcher operable to compare said received code to said codes stored in said second code memory to determine if said received code is identical to a code stored in said second code memory.

66. The system of claim 65, wherein said authorizer is operable to authorize a transaction if and only if said received code is determined to be identical to a code stored in said second code memory.

67. The system of claim 65, further comprising a second disqualifier operable to disqualify a selected code stored in said second code memory when said selected code is found by said code searcher to be identical to said received code, said disqualification preventing said disqualified code from being examined by said code searcher during subsequent searches of said codes stored in said second code memory by said code searcher.

68. The system of claim 65, further comprising a second disqualifier operable to remove from said second code memory a selected code stored in said second code memory when said selected code has been found to be identical to said received code.

69. The system of claim 1, wherein said transaction code provider comprises an first algorithmic pseudo-random code generator operable to generate a transaction code.

70. The system of claim 69, wherein said transaction code tester copses a second algorithmic pseudo-random code generator operable to generate a set of generated codes, said transaction code tester being further operable to compare said received code to each generated code of said set of generated codes.

71. The system of claim 69, wherein said authorizer is operable to authorize a transaction if and only if said received code is found to be identical to a generated code belonging to said set of generated codes.

72. The system of claim 1, wherein said user device comprises a portable device and a stationary device.

73. The system of claim 72, wherein said portable device is formed in a size and shape substantially similar to a credit card, and said stationary devices comprises a biometric sensor.

74. The system of claim 73, wherein said portable devices comprises a memory operable to store biometric data of an authorized user.

75. A user-identifying device operable to identify an authorized user of said device, comprising:
(a) a memory for storing biometric data of an authorized user of said device;
(b) a biometric sensor operable to receive current biometric data of a current user of said device;
(c) a processor operable to compare said current biometric data of said current user to said stored biometric data of said authorized user; and
(d) a communicator operable to communicate information, said information being communicated only if said processor determines that said current biometric data is similar to said stored biometric data.

76. The device of claim 75, further comprising a transaction code provider operable to provide a non-predictable transaction code useable to provoke authorization of a business transaction by a transaction authorizing authority, said transaction code being provided by said transaction code provider and communicated by said communicator only if said processor determines that said current biometric data is similar to said stored biometric data.

77. The device of claim 75, wherein said device is formed in a size and shape substantially similar to a credit card.

78. The device of claim 75, wherein said device is a smart card.

79. The device of claim 75, wherein said device conforms to ISO standard 7816.

80. The device of claim 75, further comprising a battery.

81. The device of claim 80, wherein said battery is a replaceable battery.

82. The device of claim 80, wherein said battery is a rechargeable battery.

83. The device of claim 75, further comprising a photocell operable to supply power to said device.

84. The device of claim 75, wherein said biometric sensor comprises a fingerprint sensor.

85. The device of claim 84, wherein said fingerprint sensor comprises an optical sensor.

86. The device of claim 84, wherein said fingerprint sensor comprises a capacitance sensor.

87. The device of claim 75, wherein said biometric sensor comprises a microphone.

88. The device of claim 75, wherein said biometric sensor comprises a sound recording device.

89. The device of claim 75, wherein said biometric sensor comprises a digital camera.

90. The device of claim 75, wherein said biometric sensor comprises a voice recognition system.

91. The device of claim 75, wherein said biometric sensor comprises a retinal pattern scanner.

92. The device of claim 75, wherein said biometric sensor comprises a signature verification system.

93. The device of claim 75, wherein said biometric sensor comprises an iris scanning module.

94. The device of claim 75, wherein said biometric sensor comprises a module operable to measure part of a body of a user.

95. The device of claim 75, wherein said biometric sensor comprises a module operable to measure features of a hand of a user.

96. The device of claim 75, wherein said biometric sensor comprises a module operable to measure features of a face of a user.

97. The device of claim 75, wherein said biometric sensor comprises a module operable to measure a movement of a user.

98. The device of claim 75, wherein said biometric sensor comprises a module operable to measure a behavior of a user.

99. The device of claim 75, wherein said biometric sensor comprises a module operable to characterize a pattern of physical interaction between said biometric sensor and a user.

100. The device of claim 75, further comprising biometric data of an authorized user stored in said memory.

101. The device of claim 100, wherein said biometric data of an authorized user is a calculated data resulting from a calculation based on at least one sample of input from a biometric sensor operated by a user identified as an authorized user of said device.

102. The device of claim 75, wherein said processor is operable to determine that a current user of said device is an authorized user of said device whenever detected differences between said biometric data of an authorized user and said current biometric data of a current user are less than a predetermined amount of difference.

103. The device of claim 75, wherein said communication device comprises a graphical display module operable to optically display information.

104. The device of claim 76, wherein said graphical display module is operable to optically display a transaction code provided by said transaction code provider.

105. The device of claim 103, wherein said graphical display module comprises an LCD.

106. The device of claim 103, wherein said graphical display module comprises a light-emitting element.

107. The device of claim 106, wherein said light-emitting element comprises an organic compound operable to emit light when electrically powered.

108. The device of claim 103, wherein said graphics display module comprises a plasma display.

109. The device of claim 104, wherein said graphical display module is operable to display said transaction code in a machine-readable format.

110. The device of claim 109, wherein said graphical display module is operable to display said transaction code in barcode format.

111. The device of claim 109, wherein said graphical display module is operable to display said transaction code in a format readable by an optical character recognition system.

112. The device of claim 104, wherein said graphical display module is operable to display said transaction code in a format readable by a human user and also readable by an optical character recognition system.

113. The device of claim 103, wherein said graphical display module is operable to display said information in a format readable by a human user.

114. The device of claim 103, wherein said graphical display module is operable to display said information in a machine-readable format.

115. The device of claim 114, wherein said graphical display module is operable to display said information in barcode format

116. The device of claim 104, wherein said graphical display module is operable to display said transaction code in a format readable by a human user.

117. The device of claim 75 wherein said communication device comprises a machine readable memory, and further comprises electrical connections operable to enable reading of said machine readable memory by a processor external to said device.

118. The device of claim 75, wherein said communication device comprises a transmitter.

119. The device of claim 118, wherein said transmitter comprises an emitter of radio frequencies.

120. The device of claim 118, wherein said transmitter comprises an emitter of optical frequencies.

121. The device of claim 118, wherein said transmitter comprises an emitter of infrared frequencies.

122. The device of claim 118, wherein said transmitter comprises a sound generator.

123. The device of claim 122, wherein said sound generator is operable to generate frequencies audible to the human ear.

124. The device of claim 122, wherein said sound generator is operable to generate frequencies inaudible to the human ear.

125. The device of claim 75, wherein said communication device is operable to communicate said information during a limited lapse of time, and to cease communicating said information at expiration of said lapse of time.

126. The device of claim 125, wherein said lapse of time is less than two minutes duration.

127. The device of claim 125, wherein said lapse of time is approximately 30 seconds.

128. The device of claim 76, wherein said transaction code provider comprises a first code memory operable to store a set of substantially random digital codes.

129. The device of claim 128, wherein said transaction code provider further comprises a selector operable to select a next transaction code from among codes stored in said first code memory.

130. The device of claim 129, further comprising a first disqualifier for disqualifying a code stored in said first code memory from future selection by said selector.

131. The device of claim 129, further comprising a first disqualifier operable to remove a transaction code from said first code memory, thereby preventing its future selection by said selector.

132. The device of claim 76, wherein said transaction code provider is designed and constructed to refrain from providing a transaction code previously provided by said transaction code provider.

133. A server device operable to authorize a transaction, the device comprising:
(a) a communication device operable to receive a communicated transaction request and an associated communicated code;
(b) a transaction code verifier operable to determine if said received communicated code is a valid transaction code provided by a user-identifying device; and
(c) an authorizer operable to authorize a transaction if and only if said transaction code verifier determines that said received communicated code is a transaction code provided by said a user-identifying device.

134. The device of claim 133, wherein said transaction code verifier comprises a code memory operable to store a set of substantially random digital codes.

135. The device of claim 134, further comprising a set of substantially random digital codes stored in said code memory.

136. The device of claim 133, wherein said transaction code verifier comprises a code tester for testing a received code to determine if said received code is a valid transaction code provided by a user-identifying device.

137. The device of claim 136, wherein said code tester comprises a code searcher operable to compare said received code to said codes stored in said code memory to determine if said received code is identical to a code stored in said code memory.

138. The device of claim 137, wherein said authorizer is operable to authorize a transaction if and only if said received code is determined to be identical to a code stored in said code memory.

139. The device of claim 137, further comprising a disqualifier operable to disqualify a selected code stored in said code memory when said selected code is found by said code searcher to be identical to said received code, said disqualification preventing said disqualified code from being examined by said code searcher during subsequent searches of said codes stored in said code memory by said code searcher.

140. The device of claim 137, further comprising a disqualifier operable to remove from said code memory a selected code stored in said code memory when said selected code has been found to be identical to said received code.

141. The device of claim 75, wherein said transaction code provider comprises a first algorithmic pseudo-random code generator operable to generate a transaction code.

142. The device of claim 141, wherein said transaction code tester comprises a second algorithmic pseudo-random code generator operable to generate a set of generated codes, said transaction code tester being further operable to compare said received code to each generated code of said set of generated codes.

143. The device of claim 141, wherein said authorizer is operable to authorize a transaction if and only if said received code is found to be identical to a generated code belonging to said set of generated codes.

144. The device of claim 75, further comprising a portable device and a stationary device.

145. The device of claim 144, wherein said portable device is formed in a size and shape substantially similar to a credit card, and said stationary device comprises a biometric sensor.

146. The device of claim 145, wherein said portable devices comprises a memory operable to store biometric data of an authorized user.

147. A user-identifying device providing a non-predictable transaction code useable to authenticate a business transaction, comprising:
(a) a memory for storing biometric data of an authorized user of said device;
(b) a biometric sensor operable to receive current biometric data of a current user of said device;
(c) a biometric data comparator for comparing said current biometric data of said current user to said stored biometric data of said authorized user; and
(d) a transaction code generator operable to generate a non-predictable transaction code useable to provoke authorization of a business transaction by a transaction authorizing authority, said transaction code being generated only if said biometric data comparator determines that said current biometric data is similar to said stored biometric data.

148. A method for authorizing a transaction requested by an authorized user of a transaction authorizing system and for preventing authorization of a transaction requested by an unauthorized user of said transaction authorizing system, the method comprising:
(a) utilizing a user device to:
(i) receive biometric data from a current user;
(ii) compare said received biometric data from a current user to stored biometric data from an authorized user, to determine if they are similar; and
(iii) provide and communicate a non-predictable transaction code if and only if said stored biometric data from an authorized user and said received biometric data from a current user are determined to be similar; and
(b) utilizing a server device to:
(i) receive a communicated transaction request accompanied by a communicated code;
(ii) determine whether said received communicated code is a transaction code provided by said user device;
(iii) authorize said transaction if and only if said received communicated code is determined to be a transaction code provided by said user device,
thereby enabling authorization of a transaction requested by an authorized user, and preventing authorization of a transaction requested by an unauthorized user.

149. The method of claim 148, further comprising executing a business transaction authorized by said authorizer.

150. The method of claim 148, wherein receiving biometric data from a current user includes receiving fingerprint data from said current user.

151. The method of claim 148, wherein receiving biometric data from a current user includes receiving sound data from said current user.

152. The method of claim 148, wherein receiving biometric data from a current user includes receiving voice data from said current user.

153. The method of claim 148, wherein receiving biometric data from a current user includes receiving optical data from said current user.

154. The method of claim 148, wherein receiving biometric data from a current user includes receiving data generated by said current user writing a signature.

155. The method of claim 148, wherein receiving biometric data from a current user includes receiving a retinal pattern of said current user.

156. The method of claim 148, wherein receiving biometric data from a current user includes receiving a iris pattern of said current user.

157. The method of claim 148, wherein receiving biometric data from a current user includes measuring a part of a body of said current user.

158. The method of claim 157, wherein measuring a part of a body of a user includes measuring a feature of a hand of said current user.

159. The method of claim 157, wherein measuring a part of a body of a user includes measuring a feature of a face of said current user.

160. The method of claim 148, wherein receiving biometric data from a current user includes measuring a movement of said current user.

161. The method of claim 148, wherein receiving biometric data from a current user includes measuring a behavior of said current user.

162. The method of claim 148, wherein receiving biometric data from a current user includes measuring a pattern of physical interaction between said user device and said current user.

163. The method of claim 148, wherein comparing said received biometric data from a current user to said stored biometric data from an authorized user includes determining whether detected differences between said stored biometric data of an authorized user and said received biometric data of a current user are less a predetermined amount of difference.

164. The method of claim 148, wherein communicating said non-predictable transaction code includes displaying said transaction code on a graphical display module.

165. The method of claim 148, wherein communicating said non-predictable transaction code includes displaying said transaction code in a machine-readable format.

166. The method of claim 148, wherein communicating said non-predictable transaction code includes displaying said transaction code in a barcode format.

167. The method of claim 148, wherein communicating said non-predictable transaction code includes displaying said transaction code in a format readable by an optical character recognition system.

168. The method of claim 148, wherein communicating said non-predictable transaction code includes displaying said transaction code in a format readable by a human user.

169. The method of claim 148, wherein communicating said non-predictable transaction code includes utilizing a processor external to said user device to read a machine readable memory of said user device.

170. The method of claim 148, further comprising receiving communication of a transaction code from said user device and communicating said transaction code to said server device.

171. The method of claim 148, further comprising limiting a duration of said communication of said transaction code to a period of less than two minutes.

172. The method of claim 148, further comprising limiting a duration of said communication of said transaction code to a period of approximately 30 seconds.

173. The method of claim 148, further including providing said transaction code by selecting said transaction code from among a set of substantially random digital codes stored in a memory of said user device.

174. The method of claim 148, further including verifying said received code by defining if said received code is identical to a code stored in a memory of said server device.

175. The method of claim 148, further including providing said transaction code by utilizing a processor of said user device to generate said transaction code by utilizing a pseudo-random code generation algorithm.
